(19) United States
(12) Patent Application Publication
(10) Pub. No.: US 2010/0048351 A1
(43) Pub. Date: Feb. 25, 2010

(54) METHOD FOR DYNAMICALLY DETERMINING A CLUTCH REST POINT

(75) Inventor: Robert Anthony Sayman, Meckenbeuren (DE)

Correspondence Address: DAVIS & BUJOLD, P.L.L.C., 112 PLEASANT STREET, CONCORD, NH, 03301, US

(73) Assignee: ZF FRIEDRICHSHAFEN AG, Friedrichshafen (DE)

(21) Appl. No.: 12/522,055

(22) PCT Filed: Jan. 8, 2008
(86) PCT No.: PCT/EP08/50102

§ 371 Date: Jul. 2, 2009

(30) Foreign Application Priority Data
Jan. 16, 2007 (DE) 10 2007 002 343.1

(51) Int. Cl. B60W 10/02; F16D 48/06

(52) U.S. Cl. 477/80

(57) ABSTRACT

A dynamic and event-dependent determination of a rest point of a clutch. The rest point being an actuation path shortly before a slipping region of the clutch in which the clutch still does not transmit an appreciable amount of torque but which allows very rapid attainment of a clutch position in which an appreciable torque can be transmitted. The rest point can be determined by proceeding from a basic test point by allowing for various offset or correction values. A control device determines, at favorable event-dependent times, these correction values depending on specific parameters. Then a clutch actuator is actuated such that the friction clutch is engaged up to this rest point. In this manner, increased wear of the clutch and the shifting time required to achieve the slipping region of the clutch can be minimized depending on the specific parameters.

This application is a National Stage completion of PCT/EP2008/050102 filed Jan. 8, 2008, which claims priority from German patent application serial no. 10 2007 002 343.1 filed Jan. 16, 2007.

### FIELD OF THE INVENTION

The invention relates to a method for dynamic calculation of a rest point for an automatic or automated friction clutch, whereby a control device controls a clutch actuator in such a way, that its actuator element assumes the corresponding actuator positions for that purpose and in this way establishes controllable torque transmission between a drive shaft connected to a drive engine and a power takeoff side of the friction clutch, whereby the control device, in preparation for engagement of the friction clutch for the purpose of transmission of torque, initially sets the actuator element of the clutch actuator to a rest point in which dead travel of the friction clutch is greatly reduced before transmission of torque, as opposed to a full release of the clutch.

### BACKGROUND OF THE INVENTION

Friction clutches have been used for a long time in many different contexts and are generally known. In particular in the automotive field, nearly every vehicle is equipped with a main friction clutch in the form of a plate clutch or a multiple disk clutch which allows controllable introduction of drive torque, provided by a drive engine, into the further main drive train of the vehicle. In particular it is usual to provide a friction clutch between the drive engine or its output shaft or flywheel and the input shaft of a transmission which allows a conversion of the rotational power provided by the drive engine into the rotational power desired to drive the vehicle. This is primarily necessary in the usual internal combustion engines of today, as these operate optimally in a relatively small range of rotation. Such friction clutches are also provided in all sorts of drive engines and in other vehicle assemblies, but even in many entirely non-vehicle-related assemblies, as they are switchable under a load, and thus in particular allow a start-up of a machine or a vehicle from a stopped position.

Usually multiple disk clutches are axial friction clutches of two or more plate-like friction partners called disks. Here the so-called internal disks are non-rotatably secured to a shaft but are axially able to displace, while the external disks likewise are able to axially displace and are non-rotatably secured in a hollow cylindrical carrier which is coaxial with respect to the shaft, and are arranged to be axially alternating with the internal disks. In automobile main clutches, the hollow cylindrical carrier is usually configured as a clutch bell housing rigidly coupled to the output shaft of the drive engine, often simultaneously functioning as a flywheel, while the indicated shaft on the power take-off side of the friction clutch is an input shaft of a gear-shift system. By means of an axial displacement of the disks, these can be pressed against one another, for example by spring power, allowing the multiple-disk drive to transmit a torque which depends on the type, size, and number of disks, their friction coefficient, and the compression strength, between the bell housing and the transmission input shaft.

In order to make the clutch switchable, the disks are usually pressed against one another with pressure springs, whereby a pressure plate counteracting the pressure springs for its part is pre-tensioned by an engaging spring in the direction of the engaged position of the multiple disk clutch. This pressure plate is displaceable by an actuator against the spring force of the engaging spring.

For a clutch that is operated by the driver by means of a clutch pedal, a disengaging lever is provided to disengage same. The lever can be actuated by means of the clutch pedal via a cable control. For automatic and automated or also servo-supported, manually operated clutches, an actuator drivable by an auxiliary power source is used to displace the pressure plate in such a way, that the pressure springs exert the desired pressure force on the plates corresponding to the particular requirements. Usually these are, for example, electrical actuators or pressure-activated hydraulic or pneumatic type actuators.

During operation the following clutch settings are distinguished:
a) A filly disengaged setting of the clutch in which the actuator and thus the pressure plate are set in such a way, that the plates are no longer pressed against one another by the pressure springs and, in addition, have a certain amount of axial play with respect to one another. This corresponds, for foot-pedal actuated clutches, to an entirely, or at least mostly, depressed pedal position which at the least has as a consequence a defined release of the clutch even beyond a pressure-free contact of the plates.
b) A fully engaged position in which the actuator basically exerts no force on the clutch and the pressure springs as well as the engaging springs accordingly press the plates together with maximal force. In this setting position, the clutch possesses its highest torque transmission capacity.
c) A touchpoint setting in which the clutch plates are fully in contact but largely pressure-free. From this point in the actuation path of the clutch actuation device, further displacement of the actuator in the direction of an engaged clutch leads only to a very slight axial movement of the plates and almost solely to an increase of the compression force between them.

This touchpoint strictly speaking is an axial actuation region. Since the clutch plates, on the one hand, partly touch based on their axial displaceability even with a slight play between the plates and, on the other hand, the clutch plates for a normal, oil-cooled clutch are separated from one another by a fine oil film, and since finally, owing to the oil viscosity even with fully separated plates, there is some slight torque transmission capacity present, the touchpoint or the touch region should be defined functionally here:

Touchpoint is intended to mean that point or narrow axial region of a clutch setting in which there is largely no longer any free play present between the plates, and there is a torque transmission capacity of the clutch that is slight but which does exceed the oil-viscosity-induced torque transmission. With the drive engine running and an unbraked power take-off side of the clutch, the latter is therefore set in motion for a clutch set at the touchpoint. With a braked power take-off side of the clutch, the drive shaft or the input side of the clutch is only slightly slowed and the friction heat arising in the clutch is so slight, that it leads at least briefly to a slight heating of the clutch.

In a clutch that is engaged further, a slip region of the clutch axially follows the touchpoint and is characterized by the fact, that the clutch can transmit increasingly more torque, but this transmittable torque is not sufficient to fully transmit all the torque present at the input side of the clutch. The size of the slip region is thus substantially dependent on the torque to be transmitted.

As soon as the clutch can transmit the entire applied torque without slippage, the engaged region is reached. With adequate dimensioning of the clutch, the engaged region finally contains the fully engaged setting of the clutch, in which the clutch has reached at least its maximal torque transmission capacity. If, however, the clutch was too weakly dimensioned or two heavily worn for the applied torque, it can happen, that even in the fully-engaged setting in which the maximal possible compression force is acting between the plates the clutch will slip. The slip region is thus functionally defined, while the fully engaged setting of the clutch is logically defined as the setting of the maximal torque transmission capacity of same.

For automatic and automated clutches, from here on the clutch is always understood to be a friction clutch and preferably, but not solely, a multiple-disk clutch, it is desired especially in connection with automatic or automated transmissions, that the clutch can assume its particular required state as quickly as possible.

To be sure, an especially rapid displacement of a clutch actuator, below termed an actuator for brevity's sake, entails either an increasing tolerance in the target position to be set and/or a reduction in the attainable setting precision of the actuator or a significantly increased complexity. A high degree of setting precision of the actuator is of interest primarily for engagement of the clutch between the touchpoint of the clutch and the end of the slip region.

In order to achieve an increased setting precision and at the same time a rapid attainment of the desired actuator and/or clutch position with low structural complexity, U.S. Pat. No. 5,624,350 already describes displacement of the actuator from an open-position or a fully disengaged position initially in a rapid motion mode to a rest point which is designated as an approach point. This corresponds to a clutch which is slightly less engaged in comparison with the touch point.

This ensures that, for example, for a clutch engagement command impending in the near future, expected, or currently present, the actuator can be displaced in a rapid motion mode to the approach point of the clutch, without this leading to a noticeable reaction on the clutch power take-off side. This procedural step can be carried out with maximum, or at least increased, displacement speed and only needs to be precise enough, that an appreciable torque transmission of the clutch can be avoided with certainty. Of course, it is absolutely necessary to know the clutch approach point with adequate precision for utilization of the advantages of this method.

In this regard, U.S. Pat. No. 5,624,350 suggests, that in a calibration step, first with the transmission in neutral and the transmission brake released, as well with a driven clutch input side, the actuator be displaced as slowly as possible, until the rotational sensor of the power takeoff side of the clutch directly identifies rotary motion. This point is defined as the approach point. Subsequently the process is repeated with the transmission brake engaged, in order to determine the touch point in which the clutch directly transmits appreciable torque.

The values for the actuator positions representing the approach point and the touch point can be periodically updated according to U.S. Pat. No. 5,624,350, in order to allow for wear and/or changes in the operating temperature of the clutch or the like. This entails, as mentioned, periodic recalibrations which are thus event-independent actions and do not allow for other factors in determining the point in time. In unfavorable cases, the period after which a recalibration is triggered could even occur in a high-performance acceleration process which naturally would be much less desirable.

Even if the recalibration is not performed at periodic intervals but in each case at a favorable time after the expiration of a minimum time span, this would probably be helpful with regard to the quite slow and steady wear of the clutch linings, but in practice nonetheless only conditionally leads to satisfactory results, since, for example, the operating temperature of the clutch can change greatly over a short time and numerous other factors can have an influence on the optimal position of the rest point for an impending gear shift.

In addition, allowance for the clutch temperature according to U.S. Pat. No. 5,624,350 is only possible in practice with difficulty, as a recalibration of the clutch actuation path regions in a time interval of a few seconds would be associated in the long run with a not insubstantial stress on the clutch. Besides, frequent phases of recalibration generally would disrupt driving.

On the other hand, a longer time span between calibration processes entails largely forgoing an allowance for the current operating temperature of the clutch. This would be especially critical for a clutch control in accordance with U.S. Pat. No. 5,624,350, since, for example, an appreciable torque would already be transmitted with a heat expansion-induced earlier attainment of the actual approach point in the assumed approach point set by the actuator, which along with increased wear of the friction linings of the clutch would also lead to a further intense heating of the clutch and possibly to problems with gear-changing or an unexpected spontaneous startup or acceleration of the vehicle.

The known, periodically occurring calibration of the clutch setting device is in other words especially critical, because the approach point is determined there such that at this point with neutral set and the transmission brake released there is already a rotation of the clutch power take-off side. From this point, the clutch torque to be transmitted increases greatly with increasing engagement of the clutch, so that even minor heat changes of the clutch components and/or the control device, or other influences result in a considerable increase in the transmittable torque as well as the friction heat produced, when the output shaft is braked, and thus can greatly increase wear and cause further heating.

It is further disadvantageous, that U.S. Pat. No. 5,624,350 only very generally recommends an allowance for wear and for a change in the operating temperature by means of recalibration. According to it, a diverse allowance for various factors is likewise barely provided for, like for example, an anticipatory control of the position of the clutch rest point in expectation of further conditions.

### SUMMARY OF THE INVENTION

Against this background, it is the object of the invention to present a method for dynamic calculation of a clutch rest point in which event-dependent calibration is possible. Furthermore, the clutch rest point should be defined in such a way, that elevated wear of the clutch, on the one hand, and a required shifting time before attainment of the slip region of the clutch, on the other, can be minimized depending on specific parameters.

The invention is based on the recognition, that the position of the clutch rest point advantageously should be determined not periodically but at least also as event-dependent. Further, it is based on the recognition, that the clutch rest point should be measured not solely after the start of a measurable torque transmission by the clutch but must also allow for a defined offset value which, for example, must also include the achievable positioning precision in a rapid movement mode and specific parameter changes which are briefly possible or probable.

Thus the clutch rest point in the following section is not identical with the approach point defined in U.S. Pat. No. 5,624,350, but is distinguished generally by a certain minimal safety margin from this approach point. This safety margin can be optimally set and, in particular, independent of the particular operating conditions by means of the parameters cited below which are to be advantageously allowed for in the calculation of the rest point.

Accordingly, the invention proceeds from a method for dynamic calculation of a rest position of an automatic or automated friction clutch, whereby a control device controls a clutch actuator in such a way, that its actuator element assumes the corresponding actuating settings and thus initiates a controllable torque transmission between a drive shaft connected to a drive engine and the power take-off side of the friction clutch, whereby the control device in preparation for engagement of the friction clutch for the purpose of transmission of torque, sets the actuator element of the clutch actuator initially to a rest position in which dead travel of the friction clutch is greatly reduced before transmission of torque, as opposed to a full release of the clutch. The result is, that the clutch, at the time when it is to transmit torque, is already right before the touch point and therefore can be displaced especially rapidly and nonetheless precisely to the desired region.

To achieve the object, it is provided, that the control device determines the rest position in an event-dependent manner. Subsequently an applicable control command can be sent to the clutch actuator which brings its actuator element or friction clutch to the desired rest point.

In accordance with the invention, the rest point can be determined at a favorable time, whereby, on the one hand, the timeliness of the calculation increases and, on the other hand, the determination can reliably be kept from occurring at an unfavorable time, during which, for example, the control device is heavily tasked with other calculations and thus, in the worse case, the setting of the clutch to the desired position is likewise delayed by a delay in determination of the rest point.

Here it must be kept in mind, that the concept of the determination of the point in the specific case can indeed comprise a calibration step with performance of actual clutch setting movements and an evaluation of reactions to these, but that here the determination is to be also understood as just the determination of the specific rest point to be controlled with inclusion of a base value already determined by a calibration step in the form of a computation or a selection of correction values from tables or a parameter memory.

When the control device carries out the calculation of the rest point or the rest point position on the basis of such a basic value or basic rest point of the friction clutch with inclusion of further correction factors, time-consuming and wear-associated physical calibration steps can disappear in the specific situation. In this manner, the calculation can be carried out very quickly. In addition, a determination of a base rest point by means of a calibration can be necessary only in longer time intervals, in order to obtain a deviation between a predicted wear behavior and an actual wear behavior.

An advantageous variant of the method provides, that the control device obtains the rest point position during a phase of a gear disengagement of an automatic or automated gear-shift system connected to the power take-off side of the clutch, because at this time usually important parameters are known for determination of the rest point position and the determination of the rest point position nonetheless can be carried out relatively early. Simultaneously or at least alternatively to that, it is possible to make the determination using very little processing power of the control device. Therefore, even relatively heavily stressed or weakly dimensioned control devices can assume this task without problems.

Alternatively, it can also be provided, that the control device determines the rest point position, while the automatic or automated gear-shift system is in a neutral setting. This point in time is especially suited in many cases, since in comparison to the above-described determination during the disengagement of an original gear it occurs somewhat later and the calculation results thus tend to feature a greater timeliness.

In order, however, to keep the stress on the control device at the time of gear engagement or shortly before that as low as possible, it is again desirable here, if the control device determines the rest point position directly following the presence of a neutral position in the automatic or automated gear-shift system.

Naturally, after the stoppage of the vehicle without an engaged gear or generally after a prolonged time without an engaged gear, as well as after the start of the vehicle, it is reasonable, if the control device determines for a first or repeated instance the rest point position of the friction clutch at a time, when engagement of a gear is to be expected shortly.

Furthermore, it is advantageous, if the control device determines the rest point position of the friction clutch proceeding from a base rest point with inclusion of a speed-dependent correction value, since the driving speed permits inferences regarding the general operating state of the vehicle. For example, it can be provided, that at higher driving speeds the rest point position is placed closer to the touch point of the friction clutch from which torque is transmitted, in order to facilitate the fastest possible clutch reaction.

The speed-dependent correction value can be obtained here in various ways. Since the speed signal in all modern vehicles is already available as an electrical or electronic signal, it is reasonable to check this signal to determine the speed-dependent correction value. The measurement of a measured value corresponding to the speed can also be made by obtaining the rotation of the transmission output shaft.

On the other hand, it can be advantageous if a control device obtains the speed-dependent correction value depending on the rotation of the clutch power take-off side or a transmission input shaft connected to the latter, since this value in combination with the known engine rotation makes possible a direct and especially simple allowance for the differential rotation at the clutch.

As already mentioned above, here it is often reasonable, if the control device reduces the speed-dependent correction value as the vehicle speed increases, since a desired rapid gear change can be expected at a high vehicle speed. Thus possibly even a potential tolerance-induced attainment of a friction region of the clutch can be endured, since this state appears only briefly. A heat-inducing, wear-associated, and therefore actually undesired displacement of the rest point position into the friction region of the clutch is thus by far not as critical as would be the case in a longer-lasting traffic-light stop. It must be kept in mind, therefore, that increasing speed must also be expressly understood as an increasing differential speed, for example, between the drive side and the power take-off side of the clutch.

Furthermore, it can be provided alternatively, or in addition, that the control device allows, as a correction value, a gear-dependent value GDO (gear-dependent offset) which, for example, can be read in particular very easily from a table and with an especially small computation complexity depending on an starting gear or preferably a target gear, or more preferably a combination of the two.

In particular, this gear-dependent correction value GDO can remain the same or increase with a growing gear number, meaning that the gear-dependent correction value GDO can indeed remain constant over several gear ratios but ultimately features a steady and growing course. The advantages to be achieved are based primarily on the fact that higher gears tend to correspond to higher driving speeds. Thus for a 16-gear automated gear-shift system, it can be provided, that the gear-dependent correction value GDO for starting gears RL (reverse low), RH (reverse high), gear 1, gear 2, gear 3, and gear 4 is 0, and for medium forward gears (gear 5, gear 6, gear 7, gear 8), is larger than zero and smaller than the gear-dependent correction value GDO for high gears (gear 9, gear 10, gear 11, gear 12, gear 13, gear 14, gear 15, and gear 16).

In addition, the control device can as an alternative or in addition to this allow for a shift-type dependent value STO (shift-type offset) as the correction value which, for example, can be dependent on whether it is an upshifting or a downshifting process. With upshifting processes, the shortest possible traction interruption is often desired, in order to achieve generally optimal acceleration behavior of the vehicle. With downshifting processes, the traction interruption is usually comparatively unimportant, apart from special cases, like perhaps driving on especially steep grades, so that the rest point position in these cases can lie further from the touch point of the friction clutch.

Moreover, it is reasonable, if the control device considers when obtaining the shift-type dependent value STO, whether the shift process is a shift from the neutral setting of the transmission, as is the case, for example, in starting up from a standstill. In the process especially great importance must be attached to the certain avoidance of a friction state of the clutch at the rest point, since this state can be present for an unlimited, or at least an indefinite, period of time. Accordingly, the gear-type dependent value to increase the safety margin of the rest point from the touch point of the friction clutch must usually be chosen in this case as comparatively large. The same applies, however, for other neutral shifting states of the transmission, as can occur during rolling of the vehicle with a disengaged gear on a long grade.

According to another advantageous embodiment of the invention, it is provided, that the control device to determine the shift-type dependent value STO considers, whether the current shift process is one which is carried out in a cascade transmission or only in a main transmission of a multi-group drive mechanism.

Finally, special advantages accrue, if in the determination of the rest point position of the friction clutch the control device considers as the correction value an offset value DO (disengagement offset) which it determines with a neutral position of the gear-shift system and in the presence of certain further conditions. In this way a fixed, vehicle-dependent value can be used as the base value or the base rest point of the friction clutch and is corrected by the offset value DO. The offset value DO can preferably be obtained, when as a further condition the vehicle is standing still, a potentially present transmission brake is released, and the friction clutch has a normal operating temperature.

For example, in order to ensure, even with erroneous sensor values or stray signal pickup, that the determination and setting of the rest point position in no case results in a dangerous driving state in which the vehicle, for example, inadvertently starts moving or the clutch is damaged by overheating owing to impermissibly high friction, it is finally advantageous, if the control device only varies the rest point position within preset or calculated upper and lower limits.

In addition, it must be kept in mind, that the allowance for the correction factors presented here naturally can be undertaken both individually or in any combinations. For each correction factor it is true, that it can be taken into consideration in the form of an additive or subtractive correction value, in the form of a multiplier or also in any other forms up to and including self-teaching neural networks for the determination of the rest point position of the friction clutch or the actuator element of the clutch actuator.

It is likewise possible and reasonable to also use additional parameters to form the named correction factors or with their help to obtain other correction factors and to consider them in the determination of the rest point position. For example, based on the measurement of a transmission temperature sensor an already known transmission temperature can likewise be considered as a physical-mathematical model of the expected wear of the clutch plates.

Finally, it is also possible to give the driver direct or indirect influence over the determination of the rest point position by means of direct input capabilities or evaluation of his behavior. For example, the rest point position for a very “sporty” driving behavior of the driver can be displaced further in the direction of the touch point of the friction clutch than is the case for a quiet- and comfort-minded driver.

It is also possible for automotive racing to provide a direct input capacity and possibly an override function by which the driver or a technician, for example, can displace the rest point position of the clutch even for shift processes away from the neutral setting of the transmission far in the direction of the clutch touch point or even beyond it.

### BRIEF DESCRIPTION OF THE DRAWINGS

The invention can be explained further with reference to an exemplary embodiment. For this purpose, two drawings are attached to the description. Shown thereby:

FIG. 1: A diagram for possible determination of a speed-dependent correction value for a rest point position of a clutch actuator or a friction clutch and

FIG. 2: A table representation of a possible association of gear-dependent correction values with gear ratios of a transmission with two reverse gears and sixteen forward gears.

### DETAILED DESCRIPTION OF THE PREFERRED EMBODIMENTS

For the following embodiment, let it be assumed, that a motor vehicle features a combustion engine whose output shaft is non-rotatably connected to the drivable side of a multi-disk clutch. Likewise single-plate and double-plate clutches are useable in the corresponding operating mode. The power take-off side of the multi-disk clutch is non-rotatably connected to the input shaft of an automated gear-shift system. The operating mode of the multi-disk clutch is determined by the setting of a clutch actuator which is controlled by an electronic control device.

The baseline rest point of the clutch is determined by a calibration process first performed at the end of a vehicle production line and later, for example, is repeated during factory inspections for this clutch with an actuator control value of, for example, 27 mm. This control value can be determined, for example, by slow engagement of the clutch with the engine output shaft turning and the transmission input shaft idle, as well as with the transmission gear disengaged with the transmission brake released. Here the actuator control value or the clutch point is determined at which the clutch output shaft or the transmission input shaft just begins to rotate. Then, for example, an actuator path of 2.5 mm is added as the basic safety margin in the releasing direction of the clutch, and the actuator element of the clutch actuator is displaced by the total actuator actuation path in the clutch releasing direction. This ensures, that the clutch unequivocally does not transmit torque at the rest point under normal operating conditions.

This baseline safety margin is preferably determined in such a way that with an allowance for normal clutch wear until the next expected calibration process it corresponds to the safety margin maximally desired during operation.

During driving operations the control device adapts the rest point actually to be set, for example, by reducing this baseline safety margin. The control device can determine the rest point currently to be set as soon as sensors report, that a previously engaged original gear of the automated gear-shift system is disengaged and then issue a corresponding setting command to the clutch actuator to set the rest point position of the friction clutch.

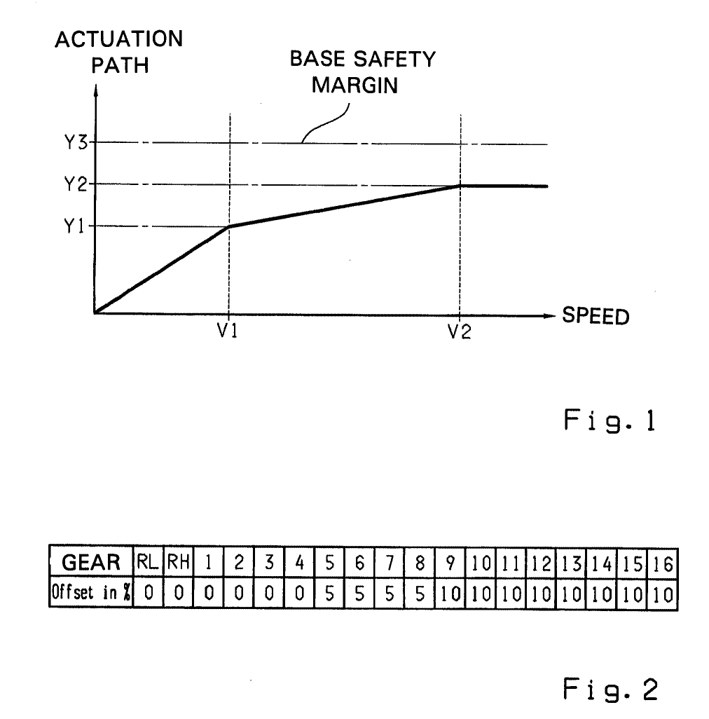

In this example, the control device detects the speed of the vehicle and from this obtains a basis rest point using a stored table or a mathematical equation. As shown schematically in FIG. 1, this can occur in that, a clutch actuation path of Y1 or Y2 respectively can be determined corresponding to the obtained speed, for example V1 or V2 which is subtracted from the maximum safety margin that is shown as a horizontal dotted line at the height of the value Y3. At a speed of 0 km/h, there is no correction of the baseline safety margin of 2.5 mm as can be seen from FIG. 1 based on the graph beginning at the axis origin, whereby the basic rest point for a standing vehicle corresponds to the baseline rest point.

At a speed V1 of 30 km/h, for example, the baseline safety margin Y3 is, however, reduced by the corresponding value Y1, here taken as 1.2 mm, whereby a basic rest point is displaced in the direction of the clutch touch point. At a speed of V2 of 80 km/h, for example, the control device reduces the baseline safety margin Y3 by the value Y2 which according to FIG. 1 is taken as 2.0 mm. The basic rest point at a speed of 80 km/h thus lies only 0.5 mm from the touch point of the clutch.

In this manner the clutch can be engaged very quickly in the presence of the corresponding command at higher driving speeds, while at lower driving speeds a somewhat greater safety margin from the touch point is present. In place of the driving speed, a rotational speed of an output shaft of the transmission can be used in the same manner as the initial parameter for reduction of the safety margin.

Alternatively or in addition to this, the new gear ratio to be engaged can be considered by means of a change in the safety margin during the setting of the clutch position. Thus the control device, for example, can read a correction factor, which is dependent on the gear ratio to be engaged, from the table shown in FIG. 2 and in this case, for example, reduce the safety margin by a further 10% (offset) for the planned engagement of the 10th gear. As FIG. 2 shows, no offset is provided in this exemplary embodiment or its amount is zero for the two reverse gears RL and RH, as well as for the starting gears 1 to 4, since usually the fastest possible gear change is not so important in the use of these starting gears.

The control device can also make further corrections of the indicated safety margin based on additional parameters. Here it is immaterial within the scope of the method according to the invention, whether now a safety margin is initially determined which is then reduced or increased in the above-described way depending on specific parameters or whether the target parameters to be calculated are, for example, the actuator position of the actuator or the position of the pressure plate. The decisive thing here is only, that ultimately the safety margin between a rest point to be set and the touch point of the clutch is optimized according to the named parameters.

1-19. (canceled)

20. A method for dynamic calculation of a rest point position of an automatic or automated friction clutch, the method comprising the steps of:
controlling a clutch actuator with a control device such that an actuator element assumes corresponding actuator positions and sets controllable torque transmission between a drive shaft, which is connected to a drive engine, and a power take-off side of the friction clutch;
initially setting the actuator element of the clutch actuator in a rest point position with the control device in preparation for engagement of the friction clutch for the purpose of the transmission of torque such that dead travel of the friction clutch, as opposed to a full release of the clutch, is greatly reduced before transmission of the torque; and
determining the rest point position with the control device in an event-dependent manner, proceeding from a basic rest point with inclusion of a correction value depending on one of vehicle driving speed and the rotational speed of a transmission output shaft.

21. The method in accordance with claim 20, further comprising the step of determining the rest point position with the control device based on the basic rest point of the friction clutch with inclusion of further correction factors.

22. The method in accordance with claim 20, further comprising the step of determining the rest point position with the control device during a phase of gear disengagement of one of an automatic and an automated gear-shift system connected to the power take-off side of the friction clutch.

23. The method in accordance with claim 20, further comprising the step of determining the rest point position with the control device when one of an automatic and an automated gear-shift system, which is connected to the power take-off side of the friction clutch, is in a neutral position.

24. The method in accordance with claim 20, further comprising the step of determining the rest point position with the control device directly after setting one of an automatic and an automated gear-shift system, which is connected to the power take-off side of the friction clutch, in a neutral position.

25. The method in accordance with claim 20, further comprising the step of determining the speed-dependent correction value, with the control device, depending on a rotational speed of a clutch output shaft.

26. The method in accordance with claim 20, further comprising the step of reducing, with the control device, the speed-dependent correction value with an increasing speed.

27. The method in accordance with claim 20, further comprising the step of allowing, via the control device, the gear-dependent value (GDO) as a correction value.

28. The method in accordance with claim 27, further comprising the step of reading, via the control device, the gear-dependent correction value (GDO) from a table.

29. The method in accordance with claim 27, further comprising the step of defining the gear-dependent correction value (GDO) to be equal to zero for a reverse gear and at least one starting gear (RL, HR, gear 1, gear 2, gear 3, gear 4),
to be greater than zero for intermediate forward gears (gear 5, gear 6, gear 7, gear 8), and
to be smaller than the gear-dependent correction value (GDO) for high gears (gear 9, gear 10, gear 11, gear 12, gear 13, gear 14, gear 15, gear 16).

30. The method in accordance with claim 20, further comprising the step of allowing, via the control device, for a shift-type-dependent value (STO) to be a correction value.

31. The method in accordance with claim 30, further comprising the step of considering, via the control device, when determinating the shift-type dependent value (STO), whether the shift is either an upshifting process or a downshifting process.

32. The method in accordance with claim 30, further comprising the step of considering, via the control device, when determinating the shift-type-dependent value (STO), whether the shift is a start-up process.

33. The method in accordance with claim 30, further comprising the step of determining, via the control device, when determining the shift-type-dependent value (STO), whether a current shift process is either executed only in a cascade transmission or a main transmission of a multi-group drive mechanism.

34. The method in accordance with claim 20, further comprising the step of allowing for, via the control device, an offset value (DO) as a correction value which is determined with a gear-shift system in a neutral setting and in a presence of a specific further condition.

35. The method in accordance with claim 34, further comprising the step of, when the further condition is that the vehicle is standing still, determining the offset value (DO), via the control device, a possibly present transmission brake is released and the friction clutch is at a normal operating temperature.

36. The method in accordance with claim 20, further comprising the step of varying the rest point position, via the control device, only within either a preset or at least one of a calculated upper limit and a lower limit.
